(19) United States
(12) Patent Application Publication
(10) Pub. No.: US 2013/0147850 A1
(43) Pub. Date: Jun. 13, 2013

(54) METHOD AND DEVICE FOR FORCE SENSING GESTURE RECOGNITION

(71) Applicants: Hao Li, Chandler, AZ (US); Papu D. Maniar, Tempe, AZ (US); Yi Wei, Chandler, AZ (US)

(72) Inventors: Hao Li, Chandler, AZ (US); Papu D. Maniar, Tempe, AZ (US); Yi Wei, Chandler, AZ (US)

(73) Assignee: Motorola Solutions, Inc., Schaumburg, IL (US)

(21) Appl. No.: 13/314,265

(22) Filed: Dec. 8, 2011

(51) Int. Cl. G09G 5/00

(52) U.S. Cl. 345/684; 345/156

(57) ABSTRACT

A method and device for force sensing gesture recognition includes a processor, a motion detector, and a force detector. A motion detector senses a motion of the mobile device corresponding to a gesture and generates gesture data, the gesture data indicative of a command to be executed. A force sensor senses a magnitude of applied force and generates force data. The magnitude of applied force is indicative of a mode in which the command is to be executed. The processor is coupled to the motion detector and the force sensor. The processor executes the command as a function of the gesture data and the force data.

### TECHNICAL FIELD

The present disclosure relates generally to an electronic device configured to receive gesture data and force data and more particularly to executing a command as a function of the gesture data and the force data.

### BACKGROUND

An electronic device may incorporate a variety of different input technologies. For example, the electronic device may include a keypad to allow a user to enter inputs. In another example, the electronic device may include a touch sensor that enables a user to enter inputs. Gesture recognition is gaining popularity in electronic devices. When properly utilized, gesture recognition enables faster and more intuitive commands. However, gesture recognition has intrinsic limitations associated therewith. Accuracy is one such limitation. Instead of a universally recognized language, there is no standard gestures library. More importantly, for a common gesture, different users perform a task differently. For example, with a left slide gesture, some users slide to the left first and then recoil back while other users prefer to move slightly to the right first then slide to the left. Numerous studies have been performed to increase accuracy by using different recognition algorithms such as hidden Markov models and Dynamic time warping methods without great success. A more straight forward method of overcoming this limitation is to limit the number of gestures performed to avoid confusion. However, this in turn limits the usefulness of the gesturing itself.

Another limitation of gesture recognition is that visual feedback is limited while performing gestures. Unlike a gaming console, the application of gestures in hand-held mobile units is limited by the fact that the motion sensing and visual display are in the same device. Accordingly, a large motion affects a user's ability to see the display. For example, tilting a device for scrolling is a commonly used gesture for many mobile applications. The amount of tilting determines a scrolling speed. However, the act of tilting the device obscures the visibility of the display and limits the visual feedback to the user. Haptic vibration and audio may also be used to provide additional feedback but are often limited to the final confirmation instead of the visualization of a process.

### SUMMARY

In one aspect, the invention is embodied in a mobile device. The mobile device includes a motion detector that senses a motion of the mobile device corresponding to a gesture. The motion detector generates gesture data that is indicative of a command to be executed. A force sensor senses a magnitude of applied force and generates force data. The magnitude of the applied force is indicative of a mode in which the command is to be executed. A processor is coupled to the motion detector and the force sensor. The processor executes the command as a function of the gesture data and the force data.

The motion detector can be one or more of an accelerometer, a gyroscope, or a mercury switch. The mobile device can also include a display for displaying information related to the command. In one embodiment, the force sensor is embodied in a control switch. In another embodiment, the force sensor is embodied in a force-sensing touch screen display.

In one embodiment, the magnitude of the applied force includes a plurality of discrete ranges of force corresponding to different modes in which the command is to be executed. In another embodiment, the magnitude of the applied force includes a constantly varying application of force.

The mobile device can also include a memory storing at least one of the gesture data and the force data. The command can be a scroll command and the mode can be a scroll rate. In one embodiment, tilting the mobile device activates the scroll command and modifying the magnitude of the applied force varies the scroll rate scroll.

In another aspect, the invention is embodied in a method for executing a command of a mobile device. The method includes sensing a motion of the mobile device corresponding to a gesture and generating gesture data. The gesture data is indicative of a command to be executed. A magnitude of applied force on a force sensor is sensed and force data is generated. The magnitude of applied force is indicative of a mode in which the command is to be executed. The command is executed as a function of the gesture data and the force data.

In one embodiment, the motion is sensed using a motion detector that can be one or more of an accelerometer, a gyroscope, and a mercury switch. A display can display information related to the command. In one embodiment, sensing the magnitude of the applied force includes applying pressure to the force sensor. The magnitude of the applied force can include a plurality of discrete ranges of force corresponding to different modes in which the command is to be executed. Alternatively, the magnitude of the applied force can include a constantly varying application of force.

In one embodiment, at least one of the gesture data and the force data can be stored in a memory. In one embodiment, the command includes a scroll command and the mode includes a scroll rate. In one embodiment, tilting the mobile device activates the scroll command and modifying the magnitude of the applied force varies the scroll rate.

### BRIEF DESCRIPTION OF THE FIGURES

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required. Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

The above and further advantages of this invention may be better understood by referring to the following description in conjunction with the accompanying drawings, in which like numerals indicate like structural elements and features in various figures. Skilled artisans will appreciate that reference designators shown herein in parenthesis indicate components shown in a figure other than the one in discussion. For example, talking about a device (10) while discussing FIG. A would refer to an element, 10, shown in figure other than FIG. A.

FIG. 1 is a perspective view of a mobile device according to one embodiment of the invention.

FIG. 2 is a block diagram of the components of the mobile unit of FIG. 1 in accordance with some embodiments.

FIG. 3 is a flowchart of a method for determining a command as a function of gesture data and force data in accordance with some embodiments.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description.

For the purposes of conciseness, many conventional techniques and principles related to motion sensing technology, need not, and are not, described in detail herein. For example, details regarding conventional motion sensors, such as accelerometers are not described in detail.

In one embodiment, the invention is embodied in a mobile device. The mobile device includes a motion detector sensing a motion of the mobile device corresponding to a gesture. The motion sensor generates gesture data that is indicative of a command to be executed. A force sensor senses a magnitude of applied force. The force sensor generates force data. The magnitude of applied force is indicative of a mode in which the command is to be executed. A processor is coupled to the motion detector and the force sensor. The processor executes the command as a function of the gesture data and the force data.

Techniques and technologies may be described herein in terms of functional and/or logical block components and various processing steps. It should be appreciated that such block components may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The following description may refer to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. The term “exemplary” is used in the sense of “example, instance, or illustration” rather than “model,” or “deserving imitation.”

Furthermore, the connecting lines shown in the various figures contained herein are intended to represent exemplary functional relationships and/or physical couplings between the various elements. Many alternative or additional functional relationships or physical connections may be present in a practical embodiment.

The exemplary embodiments may be further understood with reference to the following description and the appended drawings, wherein like elements are referred to with the same reference numerals. The exemplary embodiments describe an electronic device configured to determine a command as a function of a gesture and a force measurement. Specifically, the electronic device receives gesture data indicative of the gesture and force data as a function of the force measurement to determine the command which is based upon both factors. The electronic device, the components thereof, the gesture and gesture data, the force data and force measurement, and a related method will be discussed in further detail below.

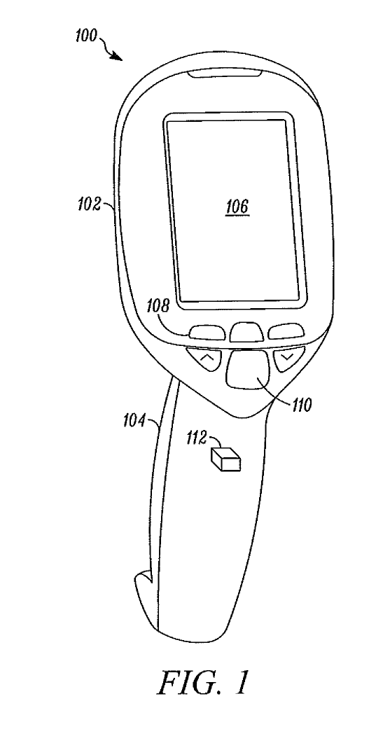

FIG. 1 is a mobile unit (MU) 100 in accordance with an exemplary embodiment of the present invention. As illustrated, the MU 100 can be any portable electronic device such as a mobile phone, a personal digital assistant, a smartphone, a tablet, a laptop, a barcode reader, etc. However, it should be noted that the MU 100 can represent any type of device that is capable of receiving gesture data and force data. The electronic device 100 can include a variety of components. As illustrated in FIG. 1, the MU 100 can include a housing 102 including a handle 104, a display 106, and an input device 108 and/or a keypad.

A force sensor 110 can be integrated with a control switch proximate to the display 106. The force sensor 110 can be fabricated using any suitable force sensing technology. For example, the force sensor 110 can be a force sensing resister (FSR). A FSR is a piezoresistivity conductive polymer, which changes resistance in a predictable manner following application of force to its surface. It is normally supplied as a polymer sheet which has had the sensing film applied by screen printing. The sensing film consists of both electrically conducting and non-conducting particles suspended in matrix. Applying a force to the surface of the sensing film causes particles to touch the conducting electrodes, changing the resistance of the film.

In one embodiment, a capacitive-based sensor can also be used as the force sensor 110. These sensors are based on the variation of capacitance between two plates when finger is brought near these plates. The capacitance between two parallel plates depends on the plate area, the distance between the plates, and the permittivity of the dielectric medium located between the plates. A capacitive touch sensor relies on the applied force either changing the distance between the plates or the effective surface area of the capacitor. In such a sensor the two conductive plates of the sensor are separated by the dielectric medium, which is also used as the elastomer to give the sensor its force-to-capacitance characteristics.

The force sensor 110 can also be integrated into a force-sensitive touch screen display (not shown). A transparent force sensor is formed by applying transparent conducting electrodes to the opposite surfaces of a transparent pressure sensing (piezoresistive) material. When pressure is applied against the sensor, the resistance across the electrodes decreases and is measured through the electrodes. This change in resistance is then converted into pressure changes.

The mobile device 100 can also include a motion detector 112 integrated with the mobile device 100. The motion detector 112 can be any suitable sensor that detects motion. For example, the motion detector 112 can be an accelerometer. In one embodiment, the motion detector 112 is a mercury switch or other gravity-based switch. The motion detector 112 can also be a gyroscope, for example.

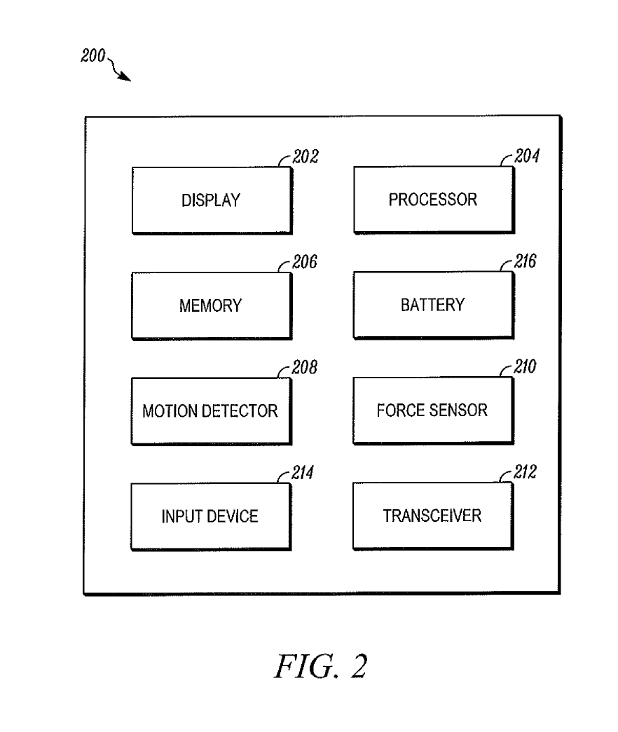

FIG. 2 is a block diagram 200 of components of the MU 100 of FIG. 1 in accordance with an exemplary embodiment of the present invention. As illustrated in FIG. 2, the MU 100 can include a display 202, a processor 204, a memory 206, a motion detector 208, a force sensor 210, a wireless transceiver 212, and an input device 214, such as a keypad. The MU 100 may include further components such as a portable power supply 216 (e.g., a battery).

The housing 102 (FIG. 1) can provide a casing for the MU 100 so that components thereof can be disposed on, at least partially on, or within the housing 102. The housing 102 can be manufactured with any conventional material to maintain a substantially rigid shape. The handle 104 can be an extension of the housing 102 to enable a user to grip the MU 100.

The display 202 can be any conventional display that is configured to display data to the user. For example, the display 202 can be an LCD display, an LED display, a touch screen display, etc. The input device 214 can be any conventional input component and can also include a keypad, keyboard, a mouse, joystick, a control button, etc. If the display 202 is a touch screen display, allowing the user to enter data through the display 202, then the input device 214 may be an optional component.

According to the exemplary embodiments, the force sensor 210 can also be an input device that is configured to receive a force input, for example, from a pressure input by a user.

As illustrated in FIG. 1, the force sensor 110 can be a button that is configured to be depressed. The output from the force sensor 110 changes as a function of a magnitude of pressure applied to the button. It should be noted that the button is only one exemplary component; the force sensor 110 can be any suitable device. For example, in another exemplary embodiment, the force sensor 110 can be a touch pad disposed on the housing 102 that is configured to be rigid and receive the force input. As will be discussed in further detail below, the force sensor 110 can be disposed on the housing 102 proximate to the handle 104. In one embodiment, the MU 100 can be operated using a single hand. For example, a user gripping the handle 104 can use a thumb to utilize the force sensor 110 while also providing a gesture.

The processor 204 can provide conventional functionalities for the MU 100. For example, the MU 100 can include a plurality of applications that are executed on the processor 204 such as an application including a web browser when connected to a network via the transceiver 212. As will be discussed in further detail below, the processor 204 of the MU 100 can also receive data to determine a command to be executed. The memory 206 can also provide conventional functionalities for the MU 100. For example, the memory 206 can store application programs and data related to operations performed by the processor 204. As will be described in further detail below, the memory 206 can also store gesture and force combinations that correspond to the command to be executed.

The motion detector 208 can be any conventional motion detecting component, such as an accelerometer. Specifically, the motion detector 208 can determine a gesture that is performed (e.g., shaking, tilting, rotating, etc.) and relay gesture data to the processor 204. The motion detector 208 can be in communication with the force sensor 210 to determine a mode of a gestured command corresponding to the application of pressure on the force sensor 210. Subsequently, the force sensor 210 can relay force data to the processor 204.

The transceiver 212 can be any conventional component configured to transmit and/or receive data. The transceiver 212 can therefore enable communication with other electronic devices directly or indirectly through a network.

According to the exemplary embodiments, the MU 100 is configured to receive gesture data via the motion detector 208 and force data via the force sensor 210. Upon receiving the gesture data and the force data, the processor 204 can determine a corresponding command that is to be executed as a function of the gesture data and the force data. The memory 206 can store a variety of different permutations of gestures and forces that are generated with the motion detector 208 and the force sensor 210.

According to one exemplary embodiment, the MU 100 can be preprogrammed with commands that correspond to the different pairings of gestures and forces. According to another exemplary embodiment, the MU 100 can be configured to accept user-defined commands that correspond to a respective pairing of the gesture and the force generated by the motion detector 208 and the force sensor 210, respectively. According to yet another exemplary embodiment, the MU 100 can be configured for the user to redefine existing commands that correspond to a set pair of gestures and forces generated by motion detector 208 and the force sensor 210. According to another exemplary embodiment, the MU 100 can be configured with any combination of the above described embodiments.

In a first exemplary application of the gesture/force pairing to determine a command, the MU 100 can be configured to sense forces at discrete levels. For example, the force sensor 210 can be configured to output three distinctive levels of force inputs. The force sensor 210 can measure the magnitude or amount of pressure applied to the force sensor 210 and depending on a predetermined range in which the pressure belongs, the processor 204 can determine which of the three distinctive levels the force input pertains. For example, the processor 204 can calibrate the pressure ranges corresponding to the force data from the of the force sensor 210. In practice, any desired number of discrete levels can be used.

This capability may be used in a variety of different modes of operation for the MU 100. For example, if a slide gesture leads to a start operation, then the force sensing may be used to set the different modes of operation such as a web mode, a phone mode, a text mode, etc. Depending on the different modes, the same gesture can open different programs or applications as a function of the force level detected. This can potentially improve a total number of gestures that can be utilized as each gesture can have a corresponding number of force pairings therewith. For example, if eight distinctive gestures may be reliably recognized in combination with three different levels of force input for a single control button, twenty four different operations can be recognized. This can be useful when the MU 100 is a delivery service terminal for which one-handed operation is often necessary and efficiency and/or speed is critical.

In a second exemplary application of the gesture/force pairing to determine a command, the MU 100 can be configured to sense forces such as an analog input for a continuous operation. For example, a scrolling function can be initiated by using a tilt motion for the gesture. Since the scrolling speed is conventionally controlled by the amount of tilting, the display is often obscured during the tilt, and thus tilting adversely affects the visual feedback of the scrolling.

According to the exemplary embodiments, the force sensing input can be used to control the scrolling speed. When the motion detector 208 detects the tilt gesture, even a very small tilt gesture, an initial scrolling speed can be initialized (e.g., slow scroll). The speed of the scroll can subsequently be controlled with the magnitude of force input to the force sensor 210. Thus, when the scrolling functionality is activated by the gesture and upon receiving of the force input, the scrolling speed can be changed (e.g., high force input results in fast scroll speed). A substantially similar operation can apply to video control. For example, a small tilt gesture to the right or left can initiate a fast forward functionality or rewind functionality of the video. The force input can control the speed at which the fast forward functionality or the rewind functionality operates (e.g., high force input results in fast scrolling through video).

It should be noted that the timing of the gesture and the force input as described above is only exemplary. According to the exemplary embodiments of the present invention, the gesture can be received first followed by the force input or vice versa. For example, a user can apply pressure to the force sensor 210 before the slide gesture to choose an operating mode or the user can apply pressure to the force sensor 210 after the gesture to confirm which application program to open. The same can apply to a scrolling operation where the force sensor 210 can be pressed before the tilt gesture to preselect a speed or the force sensor 210 may be pressed during the tilting motion to define the speed of the scrolling operation.

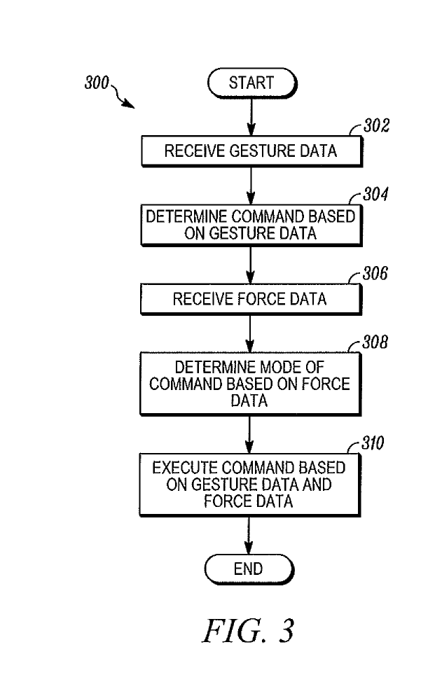

FIG. 3 is a flowchart of a method 300 for determining a command as a function of gesture data and force data in accordance with some embodiments. The method 300 relates to receiving gesture data and force data from the components of the MU 100. Thus, the method 300 will be described with reference to the MU 100 of FIG. 1 and FIG. 2 and the components thereof.

In step 302, gesture data is received by the processor 204 from the motion detector 208. As discussed above, the MU 100 can include the handle 104 that allows the user to grip the MU 100 with one hand. The user can then provide gesture data by performing a gesture motion such as tilting left/right, tilting forward/backward, shaking, etc. The motion detector 208 can measure the changes in the orientation and position of the MU 100 to determine the gesture that is being performed to ascertain the gesture data.

Accordingly, in step 304, the command type may be determined as a function of the gesture data. For example, if a web page is loaded and displayed on the display 202, the gesture data can be generated from a tilt gesture. The gesture data can indicate that the command to be executed is a scroll command.

In step 306, force data is received by the processor 204 from the force sensor 210. As discussed above, the MU 100 includes the force sensor 210, which allows a user to apply pressure to it. The force sensor 210 can convert the magnitude of pressure applied to it to the force data. The force sensor 210 can be configured to receive a variety of different force inputs (e.g., light force, medium force, and high force). Accordingly, in step 308, a mode of the command can be determined as a function of the force data. For example, when the gesture initiates a scroll command, the high force data can indicate that the scroll will be performed at a high speed.

In step 310, the command can be executed as a function of the gesture data and the force data. In the previous example, the command for a tilt is based upon the gesture data and the speed of the scroll is based upon the force data.

As discussed above, the method 300 is only exemplary in terms of the timing of the gesture data and the force data. In another exemplary embodiment, the force data may be received prior to the gesture data. However, the execution of the command is determined by both the gesture data and the force data.

The exemplary embodiments of the present invention provide a combination of force sensing and motion gesture inputs to greatly increase the number of recognizable gestures and improve the conflicts between gesturing motion and visual feedback by limiting an amount of gesture motion that is required. A mobile unit can be configured with a gesture detecting device such as a motion detector to determine gesture data that is entered by a user. The mobile unit can also be configured with a force sensor to determine force data that is input by a user. Through the pairings of the gesture data and the force data, a command can be executed as a function thereof. Specifically, the gesture data can relate to the type of command to be executed, while the force data may relate to a mode of operation indicating how the command is to be executed.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

In general, the processor includes processing logic configured to carry out the functions, techniques, and processing tasks associated with the operation of the data capture device. Furthermore, the steps of a method or algorithm described in connection with the embodiments disclosed herein may be embodied directly in hardware, in firmware, in a software module executed by the processor, or any combination thereof. Any such software may be implemented as low level instructions (assembly code, machine code, etc.) or as higher-level interpreted or compiled software code (e.g., C, C++, Objective-C, Java, Python, etc.).

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for the near-field wireless device pairing described herein. The non-processor circuits may include, but are not limited to, a radio receiver, a radio transmitter, signal drivers, clock circuits, power source circuits, and user input devices. As such, these functions may be interpreted as steps of a method to perform the near-field wireless device pairing described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage element or medium having computer readable code stored thereon for programming a computer (e.g., comprising a processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While at least one example embodiment has been presented in the foregoing detailed description, it should be appreciated that a vast number of variations exist. It should also be appreciated that the example embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

In addition, the section headings included herein are intended to facilitate a review but are not intended to limit the scope of the present invention.

Accordingly, the specification and drawings are to be regarded in an illustrative manner and are not intended to limit the scope of the appended claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function;
e) any of the disclosed elements may be comprised of hardware portions (e.g., including discrete and integrated electronic circuitry), software portions (e.g., computer programming), and any combination thereof;
f) hardware portions may be comprised of one or both of analog and digital portions;
g) any of the disclosed devices or portions thereof may be combined together or separated into further portions unless specifically stated otherwise; and
h) no specific sequence of acts or steps is intended to be required unless specifically indicated.

What is claimed is:

1. A mobile device, comprising:
a motion detector sensing a motion of the mobile device corresponding to a gesture and generating gesture data, the gesture data indicative of a command to be executed;
a force sensor sensing a magnitude of applied force and generating force data, the magnitude of applied force indicative of a mode in which the command is to be executed; and
a processor coupled to the motion detector and the force sensor, the processor executing the command as a function of the gesture data and the force data.

2. The mobile device of claim 1, wherein the motion detector is chosen from the group comprising an accelerometer, a gyroscope, and a mercury switch.

3. The mobile device of claim 1, further comprising a display for displaying information related to the command.

4. The mobile device of claim 1, wherein the force sensor comprises a control switch.

5. The mobile device of claim 1, wherein the force sensor comprises a force-sensing touch screen display.

6. The mobile device of claim 1, wherein the magnitude of the applied force comprises a plurality of discrete ranges of force corresponding to different modes in which the command is to be executed.

7. The mobile device of claim 1, wherein the magnitude of the applied force comprises a constantly varying application of force.

8. The mobile device of claim 1, further comprising a memory storing at least one of the gesture data and the force data.

9. The mobile device of claim 1, wherein the command comprises a scroll command and the mode comprises a scroll rate.

10. The mobile device of claim 9, wherein tilting the mobile device activates the scroll command and modifying the magnitude of the applied force varies the scroll rate.

11. A method for executing a command of a mobile device, comprising:
sensing a motion of the mobile device corresponding to a gesture and generating gesture data, the gesture data indicative of a command to be executed;
sensing a magnitude of applied force on a force sensor and generating force data, the magnitude of applied force indicative of a mode in which the command is to be executed; and
executing the command as a function of the gesture data and the force data.

12. The method of claim 11, wherein the motion is sensed using a motion detector chosen from the group comprising an accelerometer, a gyroscope, and a mercury switch.

13. The method of claim 11, further comprising displaying information related to the command.

14. The method of claim 11, wherein the sensing the magnitude of the applied force comprises applying pressure to the force sensor.

15. The method of claim 11, wherein the magnitude of the applied force comprises a plurality of discrete ranges of force corresponding to different modes in which the command is to be executed.

16. The method of claim 11, wherein the magnitude of the applied force comprises a constantly varying application of force.

17. The method of claim 11, further comprising storing at least one of the gesture data and the force data.

18. The method of claim 11, wherein the command comprises a scroll command and the mode comprises a scroll rate.

19. The method of claim 18, wherein tilting the mobile device activates the scroll command and modifying the magnitude of the applied force varies the scroll rate.

20. A mobile device, comprising:
means for sensing a motion of the mobile device corresponding to a gesture and generating gesture data, the gesture data indicative of a command to be executed;
means for sensing a magnitude of applied force on a force sensor and generating force data, the magnitude of applied force indicative of a mode in which the command is to be executed; and
means for executing the command as a function of the gesture data and the force data.
